(19) United States
(12) Patent Application Publication
(10) Pub. No.: US 2009/0252503 A1
(43) Pub. Date: Oct. 8, 2009

(54) OPTICAL TRANSMISSION MODULE AND OPTICAL TRANSMISSION SYSTEM

(75) Inventors: Yoshiaki Ishigami, Hitachi (JP); Kenichi Tamura, Hitachi (JP)

Correspondence Address: MATTINGLY & MALUR, P.C., 1800 DIAGONAL ROAD, SUITE 370, ALEXANDRIA, VA, 22314, US

(73) Assignee: HITACHI CABLE, LTD., Tokyo (JP)

(21) Appl. No.: 12/416,408

(22) Filed: Apr. 1, 2009

(30) Foreign Application Priority Data
Apr. 8, 2008 (JP) 2008-100501

(51) Int. Cl. H04B 10/12

(52) U.S. Cl. 398/200

(57) ABSTRACT

An optical transmission module includes one or more transmission optical devices for transmitting an optical signal L1, one or more reception optical devices for receiving another optical signal L2, and an optical member for converting optical paths for one or more optical signals L1 and one or more optical signals L2 having a different wavelength from the optical signal L1. The optical transmission module includes two or more inclined planes angled relative to the optical axis of the optical fiber, one of the two or more inclined planes has an optical filter for allowing these optical signals to partially or almost completely pass or partially reflect the optical signals L1 and L2; a reflecting plane for reflecting the optical signal L1 or L2 is formed on another one of the two or more inclined planes; a fiber lens is provided at a fiber-side end facing the optical fiber.

### TECHNICAL FIELD

The present invention relates to an optical transmission module for converting electric signals to optical signals and vice versa, which is connected to another optical transmission module through optical fibers to send and receive the converted optical signals, and also relates to an optical transmission system that uses these optical transmission modules.

### BACKGROUND ART

Network devices such as switches and routers and servers undergo distributed processing and cluster connection so that throughputs are increased.

In metal wiring, however, transmission distances, transmission capacities, volumes, and weights have been increased to meet recent demands for significantly higher data transmission and larger capacities but their limits have been reached. Demands for optical transmission modules are rapidly increasing as a substitution for metal wiring.

Conventional optical transmission modules mainly use single channels, in each of which two optical fibers are used for inbound signals and outbound signals. To further increase the transmission capacity, the number of optical transmission modules must be increased or the transmission capacity per channel must be increased.

However, the above solutions are problematic in terms of costs because an apparatus with an increased number of optical transmission modules becomes large and expensive lasers and complex high-frequency circuits are required to increase the transmission capacity.

In view of the above situation, parallel optical transmission modules are recently attracting attention, each of which can send and receive a plurality of optical signals.

This type of parallel optical transmission module has significantly reduced the volume occupied by modules per channel and the cost of the module. However, the ratio to the cost of the optical fibers through which parallel optical transmission modules are connected has increased.

FIG. 17 shows an optical transmission module 171 as an example of a conventional optical transmission module as described above. The optical transmission module 171 has a photoelectric conversion module 173 on a printed circuit board 172, and an optical fiber cable connector 174 being provided at an end of the photoelectric conversion module 173. These components are included in a housing 175, and an electric plug 176 being provided at an end of the housing 175. To use the optical transmission module 171, an optical fiber cable is connected to the optical fiber cable connector 174.

The conventional optical transmission module 171 converts positive and negative electric signals with identical intensities into optical signals and transmits the converted optical signals over an optical fiber cable, which serves as an optical transmission path. Alternatively, the optical transmission module 171 receives optical signals from a distant optical transmission module.

That is, when a single optical fiber is concerned, the conventional optical transmission module 171 just performs a transmission operation or reception operation. Accordingly, particularly when the module is used in InfiniBand, which is a high-speed interface standard, the module becomes large as whole, uses many parts, and is expensive.

Recent optical transmission modules are being required to be bidirectional modules that perform transmissions or receptions at the same time over a single optical fiber. Besides multi-fiber products, even single-fiber products have not been made compact while the transmission speed is kept high.

Patent Document 1: Japanese Patent Laid-open No. 2004-355894

Patent Document 2: Japanese Patent Laid-open No. 2006-309113

### SUMMARY OF THE INVENTION

Recently, vertical cavity surface emitting lasers (VCSELs), from which laser beams are emitted in a direction perpendicular to a wafer surface, are widely used as high-speed optical transmission lasers that use multi-mode optical fiber.

For VCSELs that occupy most of the market share, the active layer is made of Gal-xAlxAs or Gal-xInxAs (III-V group semiconductors) and the wavelength range is 0.7 to 1.0 μm, particularly 0.8 to 0.96 μm.

FIGS. 1 and 2 show the results of a spectrum characteristic simulation performed at an incident angle of 45° for an optical filter used in an optical transmission module including one of these VCSELs.

Signal light near a wavelength band of 920 nm (this signal light is referred to below as the optical signal L2) can be placed in a completely transmitted state (in which the transmittance is 100%), but it is difficult to place the P wave (polarized component with an electric field component parallel to the incident surface) of signal light near a wavelength band of 840 nm (this signal light is referred to below as the optical signal L1) in a completely reflected state (in which the reflectance is 100%).

Similarly, FIGS. 3 and 4 show states in which the optical signal L1 is placed in the completely transmitted state, in which case the optical signal L2 cannot be placed in the completely reflected state.

The S-wave component (polarized component with an electric field component perpendicular to the incident surface), P-wave component, and intermediate component of light emitted from an ordinary VCSEL are present in even ratios, so an average value of the S wave and P wave will be used without the polarized directions being distinguished.

As described above, even when the transmittance of one of the optical signals L1 and L2 can be increased to 100%, the reflectance of one of these signals cannot be increased to 100%.

There are two reasons why both the transmittance and reflectance cannot be increased to 100%.

1. The wavelength range is as narrow as 160 nm.

2. The incident angle is as large as 45°, making it difficult to place the P wave in the completely reflected state.

That is, when a bidirectional module that performs transmissions or receptions at the same time over a single optical fiber uses an ordinary VCSEL as the transmission optical device, if an optical filter that causes each optical signal to be partly or almost completely passed or reflected is not appropriately designed, cross talk occurs (for example, an optical signal having a wavelength other than an oscillated wavelength is incident to the VCSEL), in which case the optical transmission module may malfunction.

The present invention addresses the above problem with the object of providing an optical transmission module that prevents cross talk as much as possible and thereby does not malfunction.

According to a first aspect of the present invention, In an optical transmission module including one or more transmission optical devices for transmitting an optical signal, one or more reception optical devices for receiving another optical signal, and an optical member for converting optical paths for one or more optical signals L1 emitted from optical fibers and one or more optical signals L2 having a different wavelength from the optical signal L1; the optical transmission module in the present invention proposed to achieve the above object includes two or more inclined planes angled relative to the optical axis of the optical fiber, each of which has a fitting part that is mechanically fitted to the optical fiber; one of the two or more inclined planes has an optically functional member for allowing these optical signals to partially or almost completely pass or partially reflect these optical signals; a reflecting surface for reflecting these optical signals is formed on another one of the two or more inclined planes; a fiber lens is provided at a fiber-side end facing the optical fiber; the optically functional member has demultiplexing characteristics, according to the arrangement of the transmission optical device and the reception optical device, that prevents an optical signal sent from the transmission optical device from leaking into the transmission optical device at the distant optical transmission module.

According to a second aspect of the present invention, an optical filter is desirable as the optically functional member.

According to a third aspect of the present invention, In an optical transmission module including one or more transmission optical devices for transmitting an optical signal, one or more reception optical devices for receiving another optical signal, and an optical member for converting optical paths for one or more optical signals L1 emitted from optical fibers and one or more optical signals L2 having a different wavelength from the optical signal L1; the optical transmission module includes two or more inclined planes angled relative to the optical axis of the optical fiber, each of which has a fitting part that is mechanically fitted to the optical fiber; one of the two or more inclined planes has an optical filter for allowing these optical signals to partially or almost completely pass or partially reflect these optical signals; a reflecting surface for reflecting these optical signals is formed on another one of the two or more inclined planes; a fiber lens is provided at a fiber-side end facing the optical fiber; the optical filter has demultiplexing characteristics, according to the arrangement of the transmission optical device and the reception optical device, that prevents an optical signal sent from the transmission optical device from affecting the operation characteristics of a transmission optical device at the distant optical transmission module.

According to a forth aspect of the present invention, a half mirror is desirable as the optically functional member.

According to a fifth aspect of the present invention, a vertical cavity surface emitting a laser with an oscillation wavelength range of 0.7 to 1.0 μm is desirable as the transmission optical device.

According to a sixth aspect of the present invention, In an optical transmission system in the present invention, the optical transmission module described in any one of first, second and fifth aspect of the present invention comprises a first optical transmission module and a second optical transmission module; the first optical transmission module comprises one or more first transmission devices, one or more first reception devices, a first reflection plane, and a first optically functional member; the second optical transmission module comprises one or more second transmission devices, one or more second reception devices, a second reflection plane, and a second optically functional member; the first optical transmission module and the second optical transmission module are optically interconnected through one or more optical fibers; the first transmission device faces the first optically functional member and the first reception device faces the first reflection plane; the second transmission device faces the second optically functional member and the second reception device faces the second reflection plane; the transmittance of L2 through the first optically functional member is almost 100% and the transmittance of L1 through the second optically functional member is almost 100%.

According to a seventh aspect of the present invention, In an optical transmission system in the present invention, the optical transmission module described in any one of third to fifth aspect of the present invention may comprise a first optical transmission module and a second optical transmission module; the first optical transmission module may comprise one or more first transmission devices, one or more first reception devices, a first reflection plane, and a first optically functional member; the second optical transmission module may comprise one or more second transmission devices, one or more second reception devices, a second reflection plane, and a second optically functional member; the first optical transmission module and the second optical transmission module may be optically interconnected through one or more optical fibers; the first transmission device may face the first optically functional member and the first reception device may face the first reflection plane; the second transmission device may face the second optically functional member and the second reception device may face the second reflection plane; the transmittance of L1 through the first optically functional member may be 90%, the transmittance of L2 through the second optically functional member may be 90%, the reflectance of L1 on the second optically functional member may be 10%, and the reflectance of L2 on the first optically functionally member may be 10%.

According to an eighth aspect of the present invention, In an optical transmission system in the present invention, the optical transmission module described in any one of third to fifth aspect of the present invention may comprise a first optical transmission module and a second optical transmission module; the first optical transmission module may comprise one or more first transmission devices, one or more first reception devices, a first reflection plane, and a first optically functional member; the second optical transmission module may comprise one or more second transmission devices, one or more second reception devices, a second reflection plane, and a second optically functional member; the first optical transmission module and the second optical transmission module may be optically interconnected through one or more optical fibers; the first transmission device may face the first reflection plane and the first reception device may face the first optically functional member; the second transmission device may face the second reflection plane and the second reception device may face the second optically functional member; the transmittance of L1 through the first optically functional member may be 90%, the transmittance of L2 through the second optically functional member may be 90%, the reflectance of L1 on the second optically functional member may be 10%, and the reflectance of L2 on the first optically functionally member may be 10%.

According to the present invention, a bidirectional optical transmission module that can prevent cross talk as much as possible and thereby not malfunction can be achieved.

### BRIEF DESCRIPTION OF DRAWINGS

FIG. 1 illustrates an example of the transmission characteristics of an ordinary optical filter.

FIG. 2 illustrates an example of the reflection characteristics of the ordinary optical filter.

FIG. 3 illustrates another example of the transmission characteristics of the ordinary optical filter.

FIG. 4 illustrates another example of the reflection characteristics of the ordinary optical filter.

FIG. 5 schematically shows a communication system that uses optical transmission modules in a preferable first embodiment of the present invention.

FIG. 6 is a perspective view showing the entire structure of the optical transmission module shown in FIG. 5.

FIG. 7A is a general plan view indicating the main part of the optical transmission module according to the first embodiment, and FIG. 7B is a longitudinal cross-sectional view of the main part.

FIGS. 8A1, 8A2, 8B1, and 8B2 illustrate examples of demultiplexing (spectrum) characteristics of two types of optical filters used in the optical transmission modules shown in FIG. 5.

FIGS. 9A and 9B illustrate examples of combinations of the optical filters and optical device groups used in the optical transmission modules shown in FIG. 5.

FIG. 10 is a perspective view showing a connection between a ferrule and tape fibers in the optical transmission modules shown in FIG. 5.

FIG. 11 is a perspective view showing an optical member and optical device assembly in the optical transmission modules shown in FIG. 5.

FIGS. 12A and 12B schematically illustrate examples in which incorrect optical filters are selected.

FIGS. 13A1, 13A2, 13B1, and 13B2 illustrate demultiplexing characteristics of two types of half mirrors used in an optical module in a second embodiment.

FIGS. 14A and 14B illustrate examples of combinations of the optical filters and optical device groups used in the optical transmission module in the second embodiment.

FIGS. 15A and 15B illustrate other examples of combinations of the optical filters and optical device groups used in the optical transmission module in the second embodiment.

FIG. 16 is a longitudinal cross sectional view illustrating a comparative example of the optical transmission modules shown in FIG. 7.

FIG. 17 is a longitudinal cross sectional view illustrating an example of a conventional optical transmission module.

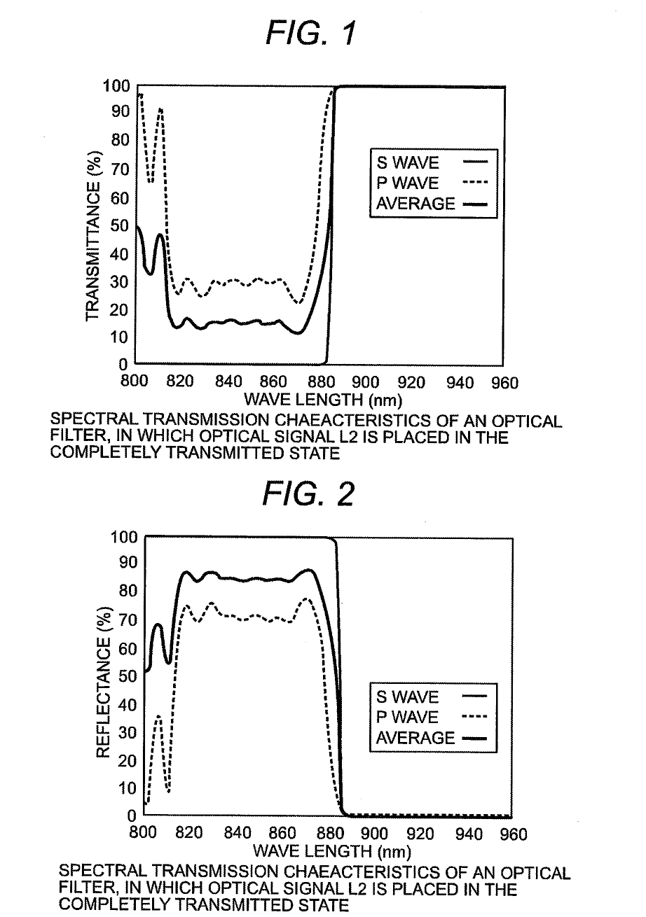

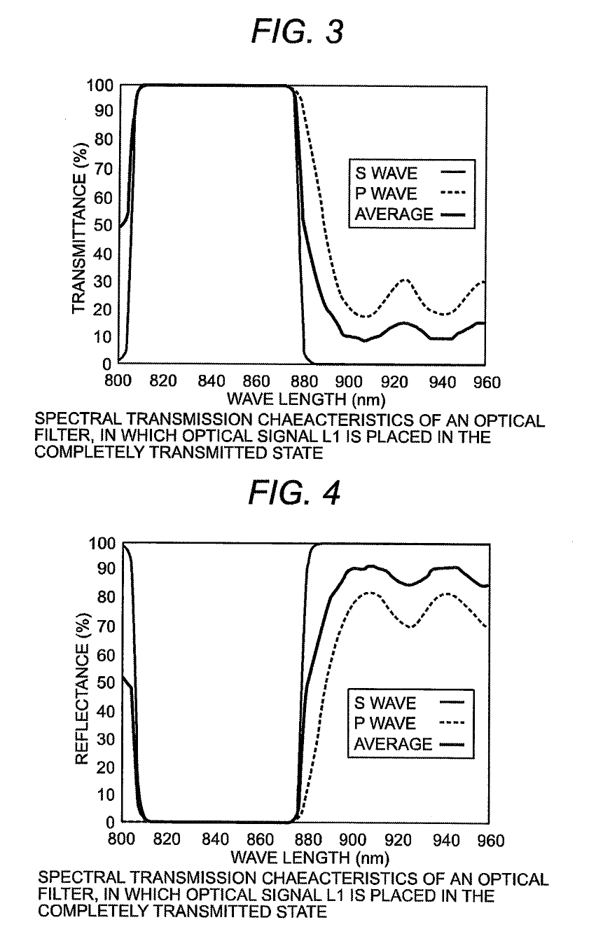

### DESCRIPTION OF EMBODIMENTS

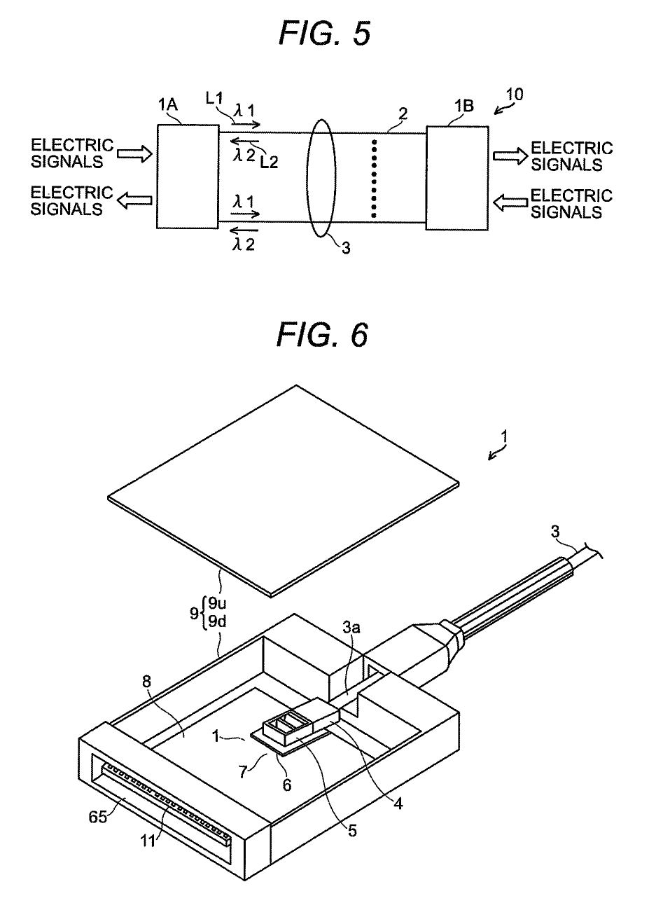

An optical transmission system using optical transmission modules in a preferable first embodiment of the present invention will be described with reference to FIG. 5.

In the optical transmission system (communication system) 10 shown in FIG. 5, optical transmission modules (multi-fiber bidirectional optical transmission modules or active connector modules) 1A and 1B (also collectively referred to below as optical transmission modules 1), according to the first embodiment, for converting electric signals to optical signals and vice versa are interconnected with a multi-fiber cable 3 formed by arranging a plurality of optical fibers 2 in parallel through which optical signals with different wavelengths are transmitted, so that transmission and reception can be carried out between the optical transmission modules 1A and 1B.

In this embodiment, a multi-mode fiber (MMF) is used as the optical fiber 2. A tape fiber formed by arranging 12 multi-mode fibers of this type for 12 transmission channels is used as the multi-fiber cable 3. Optical signals with different wavelength are transmitted through each optical fiber 2. These optical signals are optical signal L1 with a wavelength λ1, which is transmitted from the optical transmission module 1A and the optical signal L2 with a wavelength λ2, which is transmitted from the optical transmission module 1B. Semiconductor lasers (LDs) used as optical devices for transmission, which will be described later, are vertical cavity surface emitting lasers (VCSELs), each of which emits light with a wavelength near 850 nm. Accordingly, the optical signals L1 and L2 can have a wavelength interval of 25 to 80 nm between the wavelength λ1 and wavelength λ2 (for example, the wavelength λ1 is near 840 nm and the wavelength λ2 is near 920 nm).

The entire structure of the optical transmission module 1 according to the first embodiment will be described with reference to FIG. 6.

As shown in FIG. 6, the optical transmission module 1 mainly comprises a multi-fiber cable 3, a ferrule 4, an optical member 5, an optical device assembly 7 in which transmission optical devices (not shown) and reception optical devices (not shown) are mounted on a package 6 made of ceramic, a circuit board (main board) 8 to which the transmission optical devices and reception optical devices included in the optical device assembly 7 are electrically connected, and a module case 9 with an opening 65 formed at an end (lower-left end in FIG. 6) opposite to the end at which the multi-fiber cable 3 is connected.

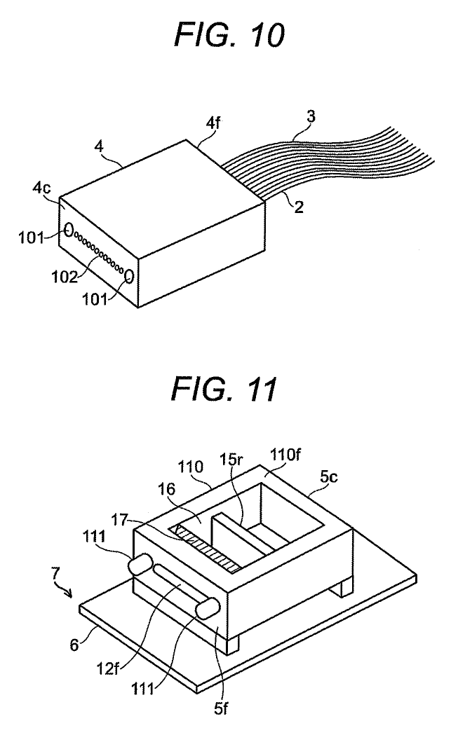

An end of the multi-fiber cable 3 is inserted into the ferrule 4 (the end is the left end in FIG. 10 referenced later). In this embodiment, a mechanically transferable (MT) ferrule, to which conductors can be connected simultaneously, is used as the ferrule 4.

The optical member 5 is mounted on the optical device assembly 7 disposed upstream of the circuit board 8. The optical member 5 sends optical signals from the transmission optical devices to the optical fibers 2 inserted into the ferrule 4. The optical member 5 also receives, at the reception optical devices, optical signals incident from the optical fibers 2 inserted into the ferrule 4.

That is, the optical member 5 converts the optical paths of the optical signals L2 sent from the optical fibers 2 and the optical signals L1, which have different wavelengths than the optical signals L2 and are incident to the optical fibers 2.

The circuit board 8 includes a plurality of connection terminals (not shown) on the front and back of an end, forming a card edge 11 for the board. Since, for example, network devices such as switches and routers and servers have adapters that electrically and mechanically fit to the card edge 11, the optical transmission module can be detachably inserted into these devices.

The module case 9 comprises a box-like lower case 9d having an opening at the top and an upper case 9u that covers the opening. The module case 9 is formed in metal die casting by using a metal material that easily releases heat, such as aluminum or zinc. The lower case 9d accommodates an end 3a of the multi-fiber cable 3, the ferrule 4, the optical member 5, the optical device assembly 7, and the circuit board 8. The upper case 9u is screwed to the lower case 9d.

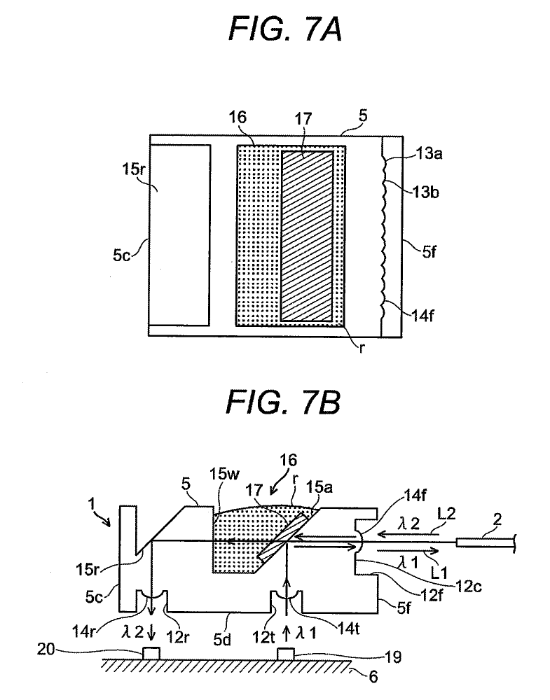

Next, the main elements of the optical transmission module 1 according to the first embodiment will be described below together with the structure and operation of the optical member 5. FIG. 7A is a general plan view of the upper surface indicating the main part of the optical transmission module according to the first embodiment, and FIG. 7B is a longitudinal cross-sectional view of the main part.

As shown in FIGS. 7A and 7B, an end (a fiber-side end or a fiber-side end into which light is entered or from which light is emitted) 5f that faces ends of the optical fibers 2 constituting the multi-fiber cable 3 (an end of the ferrule 4 shown in FIG. 4 referenced later) is formed in the optical member 5 at an end facing the optical fibers 2. The fiber-side end 5f of the optical member 5 has grooves 12f as lateral grooves of the optical fibers 2. A fiber lens array 14f comprising a plurality of fiber lenses 13a, 13b, and so on is formed on the bottom 12c of the grooves 12f, the plurality of fiber senses being formed to match the pitch at which the optical fibers 2 are arranged and being optically connected to the optical fibers 2 of the multi-fiber cable 3.

Substantially at the center of the top of the optical member 5, a filter mounting part 16 having a substantially concave part (substantially trapezoidal part when its longitudinal cross section is viewed) 9 is formed on an end 5f of the optical member 5, the module case 9 having a filter mounting plane 15a, which is one of two or more planes angled at about 45° relative to the optical axis of the optical fiber 2. A single optical filter 17 is attached to the filter mounting plane 15a by using an adhesive transparent to the light with a wavelength used, the optical filter 17 being used as the optically functional member for reflecting the optical signal L1 to be entered to the optical fiber 2 inserted into the ferrule 4 (see FIG. 10) and for allowing the optical signal L2 emitted from the optical fiber 2 inserted into the ferrule 4 to pass.

The optical filter 17 reflects optical signals in a prescribed wavelength band and allows optical signals in other wavelength bands to pass. The optical filter 17 used in this embodiment is formed with a dielectric multi-layer film to reflect the optical signal L1 with the wavelength λ1 and allow the optical signal L2 with the wavelength λ2 to pass.

After the optical filter 17 is mounted, resin “r” transparent relative to the optical signals L1 and L2 is provided in the filter mounting part 16 by potting so that the optical filter 17 is covered, preferably the filter mounting part 16 is filled, improving the reliability of the optical filter 17 and preventing dust from adhering to the optical filter 17.

The transparent resin “r” is an ultraviolet (UV) curable resin or thermosetting resin. The material of the resin is an epoxy-, acryl-, or silicone-based material. The material is transparent to light with the wavelength used. The adhesive used to attach the optical filter 17 is also made of a similar material.

A reflecting plane 15r is formed, on another end (an end opposite to the fiber side (on the connector member side)) 5c of the optical member 5, as another one of the two or more planes angled at about 45° relative to the optical axis of the optical fiber 2, the reflecting plane 15r reflecting the optical signal L2 that has emitted from the optical fiber 2 inserted into the ferrule 4 and has passed through the optical filter 17.

When the reflecting plane 15r comes into contact with a material having a largely different refractive index than the optical member 5 or a material having a larger reflectance than the optical member 5, the reflecting plane 15r can almost completely reflect the optical signal L2 (can reflect 95% or more of L2). Although, in this embodiment, the outside air is used as the material having a largely different refractive index than the optical member 5, a metal mirror formed by evaporation deposition of a metal such as Au may be used.

The package 6 has an opening at the top. A transmission optical device array 19 and a reception optical device array 20 are mounted on the internal bottom communicating with the opening; the transmission optical device array 19 comprises a plurality of transmission optical devices (such as LD devices), each of which outputs the optical signal L1 to be entered to the optical member 5, that are placed in parallel with a pitch of, for example, 250 nm so that their optical axes become parallel; the reception optical device array 20 comprises a plurality of reception optical devices (such as photodiode (PD) devices), each of which receives the optical signal L2 to be output from the optical member 5, that are placed in parallel with a pitch of, for example, 250 nm.

Since, in this embodiment, optical fibers 2 constitute the multi-fiber cable 3, a vertical cavity surface emitting laser (VCSEL) array comprising 12 LD devices is used as the transmission optical device array 19, and a PD array comparing 12 PD devices is used as the reception optical device array 20.

A concave groove 12t is formed as an optical device lateral groove at the bottom (an end on the h-order potash device side or the receiving/emitting plane on the optical device side) 5d at an end of the optical member 5, which is different from the end 5f of the optical member 5. A transmission lens array 14t comprising a plurality of transmission lenses (12 transmission lenses in this embodiment) is formed on the internal upper surface of the concave groove 12t, according to the arrangement pitch of the transmission optical device array 19.

A concave groove 12r is also formed as another optical device lateral groove at the bottom 5d of another end of the optical member 5. A reception lens array 14r comprising a plurality of reception lenses (12 reception lenses in this embodiment) is formed on the internal upper surface of the concave groove 12r, according to the arrangement pitch of the reception optical device array 20.

The transmission lenses of the transmission lens array 14t are disposed on the bottom 5d of the optical member 5 so that the transmission lenses face the LD devices of the transmission optical device array 19; the reception lenses of the reception lens array 14r are disposed on the bottom 5d of the optical member 5 so that the reception lenses face the PD devices of the reception optical device array 20.

Since the optical member 5 has the lens arrays in the internal upper surfaces of the concave grooves 12t and 12r, when optical members 5 are placed side by side on, for example, a tray, during an assembling process in manufacturing, the arrangement of the lens arrays prevents the lens surfaces from touching the tray. Accordingly, the lens surfaces can be protected and thus the optical member 5 can be easily handled.

The optical member 5 is integrally injection molded from optical resin transparent relative to the optical signals L1 and L2. Applicable optical resin materials include acryl resin, polycarbonate (PC) resin, and cyclo olefin polymer (COP) resin. Polyether imide (PEI), which is a super-engineering plastic, is suitable to increase the material intensity and heat resistance. When these resin materials have a refractive index within the range of 1.45 to 1.65, any of these materials may be used in the optical member 5 in this embodiment. When, however, the optical signal loss caused by the resin material is slight, its refractive index is not limited to this range.

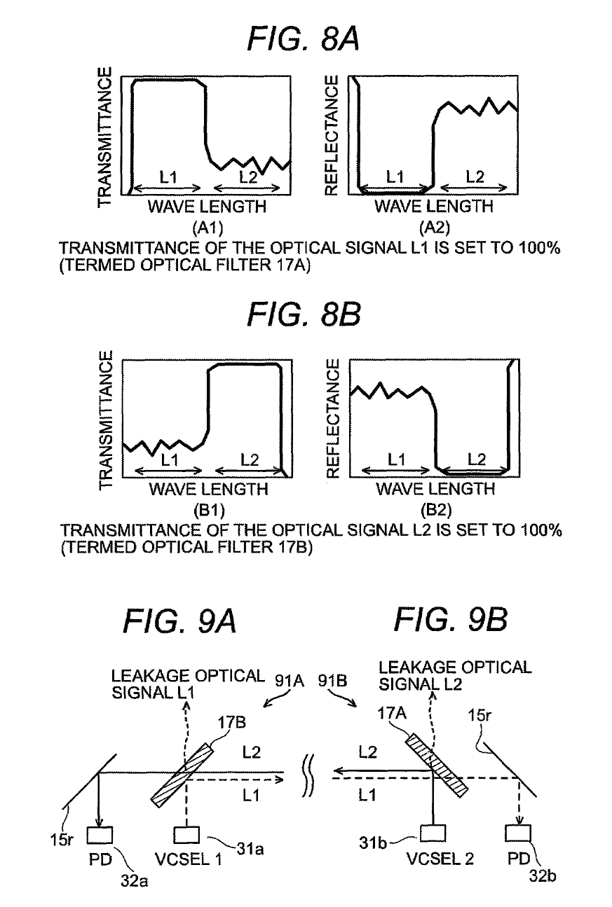

The optical filter 17 used in the optical transmission module 1 will be described below in detail with reference to FIGS. 8A1, 8A2, 8B1, and 8B2.

FIGS. 8A1 and 8A2 show the results of a simulation in which the transmittance of the optical signal L1 is set to 100% for the optical filter 17, and FIGS. 8B1 and 8B2 show the results of a simulation in which the transmittance of the optical signal L2 is set to 100%. It can be thought from FIGS. 8A1, 8A2, 8B1, and 8B2 that the optical filter 17 has two types of spectrum characteristics that depend on the wavelength range in which the transmittance is 100%. Optical filters 17 having these two types of spectrum characteristics are classified as the optical filter 17A and optical filter 17B.

It was found that to use the optical transmission module 1 in FIG. 5 to perform highly reliable optical transmission at high speed, the two types of optical filters 17A and 17B must be appropriately selected to limit the structure. FIGS. 9A and 9B show exemplary optimum structures of the optical transmission module 1.

As shown in FIGS. 9A and 9B, for example, the optical transmission module 91B (equivalent to the optical transmission module 1B in FIG. 5) uses the optical filter 17A that allows the optical signal L1 to completely pass, and the optical transmission module 91A (equivalent to the optical transmission module 1A in FIG. 5) uses the optical filter 17B that allows the optical signal L2 to completely pass; a pair of the optical filters 17A and 17B constitutes the optical filter 17. The optical filters 17A and 17B have demultiplexing characteristics, according to the arrangement of the transmission optical device array 19 and reception optical device array 20, that prevents an optical signal sent from the transmission optical device array 19 from leaking into the transmission optical device at the distant optical transmission module.

The transmission optical device array 19 in FIG. 7B comprises a first transmission optical device group 31a and a second transmission optical device group 31b; the first transmission optical device group 31a comprises a plurality of first transmission optical devices from which to send the optical signal L1 are placed so that their optical axes become parallel (placed in a direction into the drawing sheet in FIG. 9A); the second transmission optical device group 31b comprises a plurality of second transmission optical devices from which to send the optical signal L2 are placed so that their optical axes become parallel (placed in a direction out of the drawing sheet in FIG. 9B).

The reception optical device array 20 in FIG. 7B comprises a first reception optical device group 32a and a second reception optical device group 32b; the first reception optical device group 32a comprises a plurality of first reception optical devices that receive the optical signal L2, the plurality of first reception optical devices being aligned facing the first transmission optical devices; the second reception optical device group 32b comprises a plurality of second reception optical devices that receive the optical signal L1.

The first transmission optical device group 31a is disposed downstream of the optical filter 17B, and the second transmission optical device group 31b is disposed downstream of the optical filter 17A. The first and second reception optical device groups 32a and 32b are disposed downstream of the reflecting plane 15r.

Next, the ferrule 4 will be described in detail with reference to FIG. 10 and an optical member 110 will be described in detail with reference to FIG. 11.

As shown in FIG. 10, the ferrule 4 is shaped like a rectangular parallelepiped, on an end 4c of which two ferrule fitting grooves 101 are formed at both ends to have the ferrule 4 mechanically fit to the optical member 110. A plurality of fiber insertion holes 102 (12 holes in FIG. 10) are formed between the two ferrule fitting grooves 101, the fiber insertion holes 102 being through-holes extending from the end 4c to another end 4f. The fiber insertion holes 102 are spaced at the same pitch as the fiber lenses 13a, 13b, and so on so that the fiber insertion holes of the fiber lens array 14f face the fiber lenses 13a, 13b, and so on.

As shown in FIG. 11, two fitting projections 111 are formed on an end 5f of the optical member 110 to mechanically fit to the two ferrule fitting grooves 101 in FIG. 10.

When the two fitting projections 111 and two ferrule fitting grooves 101 are mutually fitted, joint parts (connection parts) are formed, enabling the end 5f of the optical member 110 and the end 4c of the ferrule 4 to be mutually abutted and thereby the fibers 2 and the optical member 110 to be optically interconnected.

Of course, fitting grooves may be formed in the optical member to accept the ferrule, and fitting projections may be formed on the ferrule to fit to the optical member. A flat part 110f shaped like a rectangular frame is formed at the upper edge of the optical member 110 so that the optical member 110 is caught by a collet chuck of a mounter on which to mount optical parts or electric parts.

Effects of the first embodiment will be described next.

In the optical transmission module 1 shown in FIGS. 6 and 7, the 12 electric signals corresponding the channels are sent from the circuit board 8, and converted to the optical signals L1 with the wavelength λ1 in the transmission optical device array 19, after which the optical signals L1 are converted to collimated light by the transmission lens array 14t in a lens array 24 on the optical device side (in the case of the optical member 5, the optical signals L1 are converted to collimated light by its transmission lens array 14t) and the collimated light is entered to the optical member 110. The optical signals L1 are then reflected by the optical filter 17 and focused by the fiber lens array 14f, emitted from the optical member 110, and entered to the optical fibers 2 of the multi-fiber cable 3. The optical signals L1 are sent to the distant optical transmission module in this way.

The 12 optical signals L2 with the wavelength of λ2, corresponding to the channels, are sent from the distant optical transmission module, and emitted from the optical fibers 2 of the multi-fiber cable 3, after which the optical signals L2 are converted to collimated light by the fiber lens array 14f in the optical member 110 and the collimated light is entered to the optical member 110. The optical signals L2 pass through the optical filter 17, are reflected by the reflecting plane 15r, and are emitted from the optical member 110. The emitted optical signals L2 are focused by the reception lens array 14r in lens array 24 on the optical device side, converted to 12 electrical signals by the reception optical device array 20, and sent to the circuit board 8. The optical signals L2 are from the distant optical transmission module are received in this way.

As described with reference to FIGS. 9A and 9B, the optical transmission module 1 uses the optical filters 17A and 17B shown in FIG. 8 as the appropriate optical filters 17. In the optical transmission module 91A in FIG. 9A, the optical filter 17B is set so that the optical signal L2 completely passes through, so the optical signal L2 does not leak into the transmission optical devices (VCSEL1) constituting the first transmission optical device group 31a.

In the optical transmission module 91B in FIG. 9B, the optical filter 17A is set so that the optical signal L1 completely passes through, so the optical signal L2 does not leak into the transmission optical devices (VCSEL2) constituting the second transmission optical device group 31b.

In the above description, the transmittance of the optical signal L1 through the optical filter 17B is 100% and the transmittance of the optical signal through the optical filter 17A is also 100%. In practice, however, a transmittance of 97% is adequate. When the transmittance is 97%, the remaining 3% of light leaks. However, the amount of light leaking is reduced depending on the reflectance or transmittance of the optical filter in the distant optical transmission module described later, and thereby the effect of the light leak on the optical device is negligible.

Accordingly, the optical transmission module 1 becomes a highly reliable bidirectional optical transmission module that prevents cross talk as much as possible and thereby does not malfunction.

The main part of the optical transmission module 1 can be structured just by forming the fiber lens array 14f, filter mounting part 16, and reflecting plane 15r in the optical member 110 and mounting a single optical filter 17 in the filter mounting part 16, resulting in a simpler structure than the conventional optical transmission module. In addition, bidirectional communication is possible, reducing the number of optical fibers 2 to half the number of optical fibers in one-way communication.

For the optical transmission module according to the present invention, when the wavelength interval of the optical signals is a narrow band from 25 to 80 nm and the incident angle with respect to the optical filter is large, the optical filter 17 must be carefully selected.

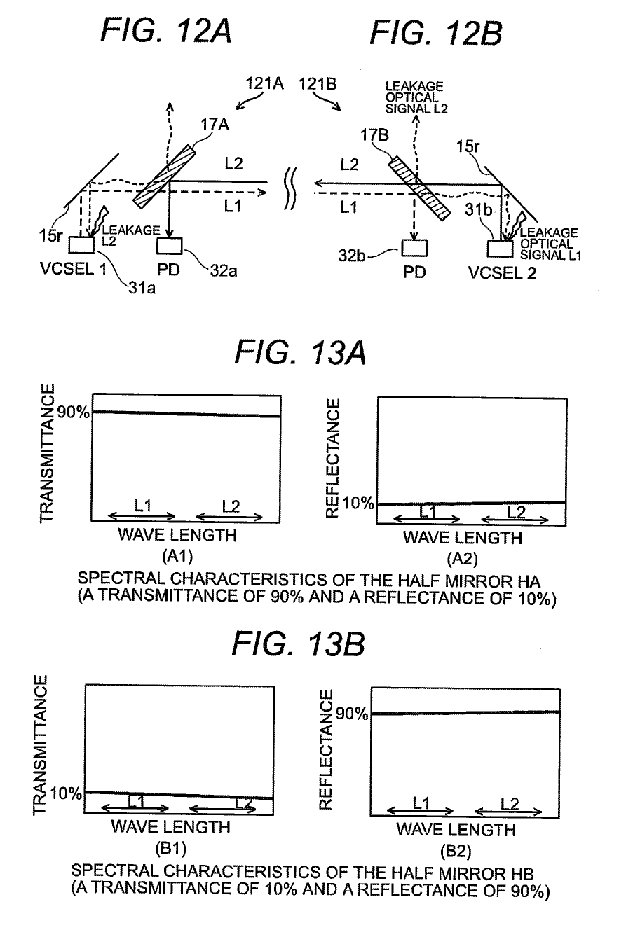

For example, suppose that, as shown in FIGS. 12A and 12B, the first transmission optical device group 31a and second transmission optical device group 31b are disposed downstream of the reflecting plane 15r, the first reception optical device group 32a is disposed downstream of the optical filter 17A, and the second reception optical device group 32b is disposed downstream of the optical filter 17B.

Then, as shown in FIG. 12A, the optical transmission module 121A cannot completely reflect the optical signal L2 at the optical filter 17A (in practice, a reflectance of 97% or more cannot be achieved), so part of the optical signal L2 leaks into the transmission optical devices (VCSEL1) constituting the first transmission optical device group 31a, causing the VCSEL1 to malfunction.

In FIG. 12B, the optical transmission module 121B cannot completely reflect the optical signal L1 at the optical filter 17B so part of the optical signal L1 leaks to the transmission optical devices (VCSEL2) constituting the second transmission optical device group 31b, causing the VCSEL2 to malfunction.

Next, a second embodiment will be described.

Although, in the first embodiment, the optical filter 17 that allows an optical signal to pass or reflects it depending on the wavelength that has been used as the optically functional member, a half mirror can also be used instead of the optical filter 17. Half mirrors lack a wavelength selecting function for performing demultiplexing or multiplexing according to the wavelength, but they allow the transmittance or reflectance of an optical signal with a predetermined wavelength to be set to an arbitrary value. That is, half mirrors have an almost fixed transmittance or reflectance, independent of the wavelength.

The half mirrors used in the optical transmission modules in the second embodiment are half mirrors HA and HB; the spectral characteristics of the half mirror HA is shown in FIGS. 13A1 and 13A2, a transmittance of 90% and a reflectance of 10% being obtained at a central wavelength of 880 nm; the spectral characteristics of the half mirrors HB is shown in FIGS. 13B1 and 13B2, a transmittance of 10% and a reflectance of 90% being obtained at a central wavelength of 880 nm.

As described above, it is very difficult to increase the reflectance of the P wave, so the half mirror HA with low reflectance can reduce the number of layers of a multi-layer reflecting film more than the half mirror HB with high reflectance, thus reducing the cost.

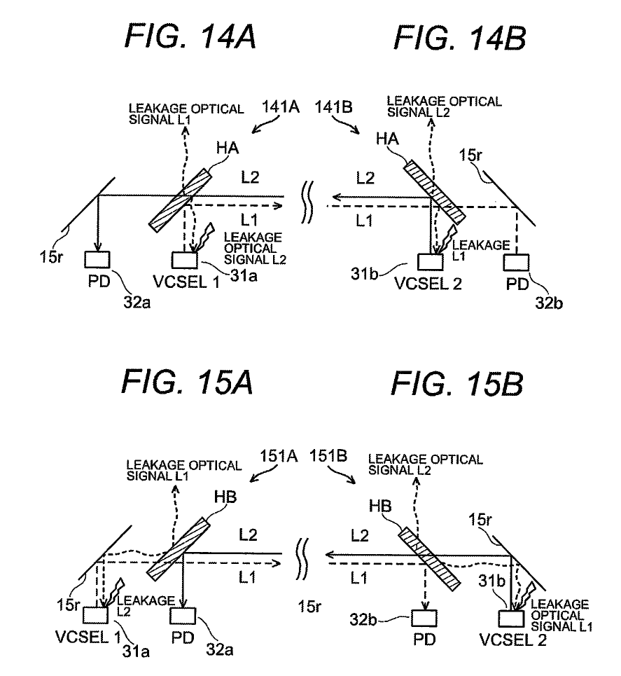

FIGS. 14A and 14B show exemplary structures of the optical devices 141A and 141B according to the second embodiment, which are optimum in highly reliable high-speed transmissions, in which the optical devices use the half mirror HA, which allows 90% of the optical signals L1 and L2 to pass and reflects 10% of these signals, as the optically functional member. The half mirror HA has spectrum characteristics, according to the arrangement of the transmission optical device array 19 and reception optical device array 20, that prevents an optical signal sent from the transmission optical device array 19 from affecting the operation characteristics of the transmission optical devices of the distant optical transmission module.

The first transmission optical device group 31a and second transmission optical device group 31b are disposed downstream of the half mirror HA, and the first reception optical device group 32a and second reception optical device group 32b are disposed downstream of the reflecting plane 15r.

The branching ratio (transmittance versus reflectance) of the half mirror HA in the optical devices 141A and 141B is set at 9:1. As shown in FIG. 14A, therefore, even when the optical signal L2 from the VCSEL2 in the distant optical transmission module is entered into the VCSEL1, the amount of light entered is about 1/81 (=1/9×1/9) of the total amount of light of the VCSEL2, preventing the VCSEL1 from malfunctioning. This is also true in FIG. 14B.

Accordingly, the optical devices 141A and 141B provide the same effect as the optical transmission modules 91A and 91B in FIGS. 9A and 9B.

The half mirror HB may be used as shown in FIGS. 15A and 15B as the half mirror used in the optical device in the second embodiment.

The first transmission optical device group 31a and second transmission optical device group 31b are disposed downstream of the reflecting plane 15r, and the first reception optical device group 32a and second reception optical device group 32b are disposed downstream of the half mirror HB.

The branching ratio (transmittance versus reflectance) of the half mirror HB in the optical devices 151A and 151B is set at 1:9. As shown in FIG. 15A, therefore, even when an optical signal L2 from the VCSEL2 in the distant optical transmission module is entered into the VCSEL1, the amount of light entered is about 1/81 (=1/9×1/9) of the total amount of light of the VCSEL2, preventing the VCSEL1 from malfunctioning. This is also true in FIG. 15B.

The optical transmission modules 91A, 91B, 141A, 141B, 151A, and 151B in the above embodiments provide further effects. The optical transmission modules have a stipulated optical output power released to the outside.

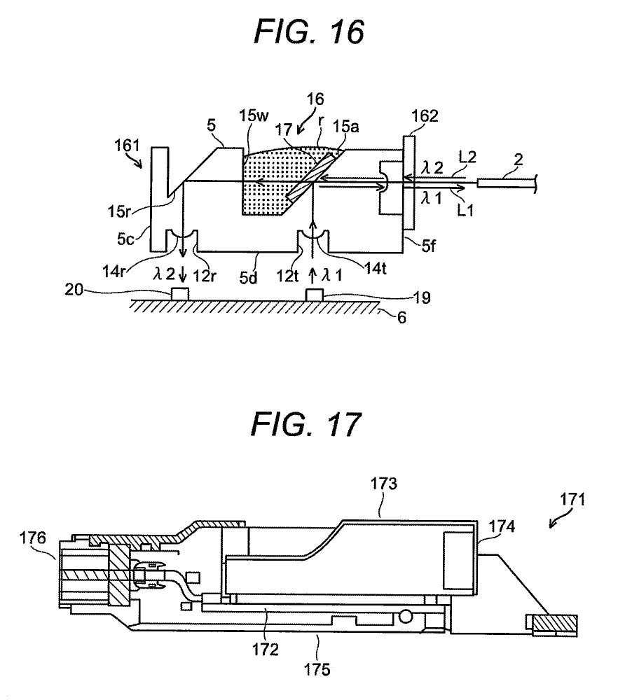

Accordingly, an optical transmission module 161 shown in FIG. 16, which is a comparative example of the optical transmission module 1, for example, must have a light attenuating filter 162 (indicated by dash-dot lines in FIG. 16) on an end of the optical member 5 on the fiber side to reduce the power of the light output from the VCSEL to a stipulated value.

For the optical transmission modules 91A, 91B, 141A, 141B, 151A, and 151B in the above embodiments, however, part of the optical signal L1 from the VCSEL1 positively leaks into the upper part of the optical transmission modules in FIGS. 9A, 14A, and 15A and part of the optical signal L2 from the VCSEL2 positively leaks into the upper part of the optical transmission modules in FIGS. 9B, 14B and 15B. When the optical filters 17A and 17B and the half mirrors HA and HB are optimally designed, the power of the light output from the optical transmission modules 91A, 91B, 141A, 141B, 151A, and 151B can be reduced to or below the stipulated value, enabling the light attenuating filter 162 used in the comparative example to be eliminated.

If an incorrect optical filter is selected as shown in FIG. 12, not only the VSCEL1 malfunctions but also an additional cost due to the need for the light attenuating filter 162 is required.

Although the above embodiments have been described by using examples in which the optical signal L1 with the wavelength λ1 and the optical signal L2 with the wavelength λ2 are used in multi-fiber bidirectional communication, three or more optical signals with different wavelengths may be used. In this case, since as many optical filters as the number of signals is required, the structures of the optical members 5 and 110 should be changed accordingly.

It will be obvious to those having skills in the art that many changes may be made in the above-described details of the preferred embodiments of the present invention. The scope of the invention, therefore, should be determined by the following claims.

1. An optical transmission module including one or more transmission optical devices for transmitting an optical signal, one or more reception optical devices for receiving another optical signal, and an optical member for converting optical paths for one or more optical signals L1 emitted from optical fibers, and one or more optical signals L2 having a different wavelength from the optical signal L1; the optical transmission module comprising:
two or more inclined planes angled relative to an optical axis of the optical fiber, each of which has a fitting part that is mechanically fitted to the optical fiber;
an optically functional member disposed on one of the two or more inclined planes, the optically functional member allowing the optical signals to partially or almost completely pass or partially reflect the optical signals;
a reflecting surface formed on another one of the two or more inclined planes, the reflecting surface reflecting the optical signals; and
a fiber lens disposed at a fiber-side end facing the optical fiber;
wherein the optically functional member has demultiplexing characteristics, according to the arrangement of the transmission optical device and the reception optical device, that prevent an optical signal sent from the transmission optical device from leaking into another transmission optical device at a distant optical transmission module.

2. The optical transmission module according to claim 1, wherein the optically functional member is an optical filter.

3. An optical transmission module including one or more transmission optical devices for transmitting an optical signal, one or more reception optical devices for receiving another optical signal, and an optical member for converting optical paths for one or more optical signals L1 emitted from optical fibers, and one or more optical signals L2 having a different wavelength from the optical signal L1; the optical transmission module comprising:
two or more inclined planes angled relative to an optical axis of the optical fiber, each of which has a fitting part that is mechanically fitted to the optical fiber;
an optically functional member disposed on one of the two or more inclined planes, the optically functional member allowing the optical signals to partially or almost completely pass or partially reflect the optical signals;
a reflecting surface formed on another one of the two or more inclined planes, the reflecting surface reflecting the optical signals; and
a fiber lens disposed at a fiber-side end facing the optical fiber;
wherein the optically functional member has demultiplexing characteristics, according to the arrangement of the transmission optical device and the reception optical device, that prevent an optical signal sent from the transmission optical device from affecting the operation characteristics of another transmission optical device at a distant optical transmission module.

4. The optical transmission module according to claim 3, wherein the optically functional member is a half mirror.

5. The optical transmission module according to claim 1, wherein the transmission optical device is a vertical cavity surface emitting laser with an oscillation wavelength range of 0.7 to 1.0 μm.

6. An optical transmission system, wherein:
the optical transmission module according to claim 1 comprises a first optical transmission module and a second optical transmission module;
the first optical transmission module comprises one or more first transmission devices, one or more first reception devices, a first reflection plane, and a first optically functional member;
the second optical transmission module comprises one or more second transmission devices, one or more second reception devices, a second reflection plane, and a second optically functional member;
the first optical transmission module and the second optical transmission module are optically interconnected through one or more optical fibers;
the first transmission device faces the first optically functional member and the first reception device faces the first reflection plane;
the second transmission device faces the second optically functional member and the second reception device faces the second reflection plane; and
a transmittance of L2 through the first optically functional member is almost 100% and a transmittance of L1 through the second optically functional member is almost 100%.

7. An optical transmission system, wherein:
the optical transmission module according to claim 3 comprises a first optical transmission module and a second optical transmission module;
the first optical transmission module comprises one or more first transmission devices, one or more first reception devices, a first reflection plane, and a first optically functional member;
the second optical transmission module comprises one or more second transmission devices, one or more second reception devices, a second reflection plane, and a second optically functional member;
the first optical transmission module and the second optical transmission module are optically interconnected through one or more optical fibers;
the first transmission device faces the first optically functional member and the first reception device faces the first reflection plane;
the second transmission device faces the second optically functional member and the second reception device faces the second reflection plane; and
a transmittance of L1 through the first optically functional member is 90%, a transmittance of L2 through the second optically functional member is 90%, a reflectance of L1 on the second optically functional member is 10%, and a reflectance of L2 on the first optically functionally member is 10%.

8. An optical transmission system, wherein:
the optical transmission module according to claim 3 comprises a first optical transmission module and a second optical transmission module;
the first optical transmission module comprises one or more first transmission devices, one or more first reception devices, a first reflection plane, and a first optically functional member;
the second optical transmission module comprises one or more second transmission devices, one or more second reception devices, a second reflection plane, and a second optically functional member;
the first optical transmission module and the second optical transmission module are optically interconnected through one or more optical fibers;
the first transmission device faces the first reflection plane and the first reception device faces the first optically functional member;
the second transmission device faces the second reflection plane and the second reception device faces the second optically functional member; and
a transmittance of L1 through the first optically functional member is 10%, a transmittance of L2 through the second optically functional member is 10%, a reflectance of L1 on the second optically functional member is 90%, and a reflectance of L2 on the first optically functionally member is 90%.

9. The optical transmission module according to claim 3, wherein the transmission optical device is a vertical cavity surface emitting laser with an oscillation wavelength range of 0.7 to 1.0 μm.

10. An optical transmission system, wherein:
the optical transmission module according to claim 2 comprises a first optical transmission module and a second optical transmission module;
the first optical transmission module comprises one or more first transmission devices, one or more first reception devices, a first reflection plane, and a first optically functional member;
the second optical transmission module comprises one or more second transmission devices, one or more second reception devices, a second reflection plane, and a second optically functional member;
the first optical transmission module and the second optical transmission module are optically interconnected through one or more optical fibers;
the first transmission device faces the first optically functional member and the first reception device faces the first reflection plane;
the second transmission device faces the second optically functional member and the second reception device faces the second reflection plane; and
a transmittance of L2 through the first optically functional member is almost 100% and a transmittance of L1 through the second optically functional member is almost 100%.

11. An optical transmission system, wherein:
the optical transmission module according to claim 4 comprises a first optical transmission module and a second optical transmission module;
the first optical transmission module comprises one or more first transmission devices, one or more first, reception devices, a first reflection plane, and a first optically functional member;
the second optical transmission module comprises one or more second transmission devices, one or more second reception devices, a second reflection plane, and a second optically functional member;
the first optical transmission module and the second optical transmission module are optically interconnected through one or more optical fibers;
the first transmission device faces the first optically functional member and the first reception device faces the first reflection plane;
the second transmission device faces the second optically functional member and the second reception device faces the second reflection plane; and
a transmittance of L1 through the first optically functional member is 90%, a transmittance of L2 through the second optically functional member is 90%, a reflectance of L1 on the second optically functional member is 10%, and a reflectance of L2 on the first optically functionally member is 10%.

12. An optical transmission system, wherein:
the optical transmission module according to claim 4 comprises a first optical transmission module and a second optical transmission module;
the first optical transmission module comprises one or more first transmission devices, one or more first reception devices, a first reflection plane, and a first optically functional member;
the second optical transmission module comprises one or more second transmission devices, one or more second reception devices, a second reflection plane, and a second optically functional member;
the first optical transmission module and the second optical transmission module are optically interconnected through one or more optical fibers;
the first transmission device faces the first reflection plane and the first reception device faces the first optically functional member;
the second transmission device faces the second reflection plane and the second reception device faces the second optically functional member; and
a transmittance of L1 through the first optically functional member is 10%, a transmittance of L2 through the second optically functional member is 10%, a reflectance of L1 on the second optically functional member is 90%, and a reflectance of L2 on the first optically functionally member is 90%.
